(19) United States
(12) Patent Application Publication
(10) Pub. No.: US 2020/0180240 A1
(43) Pub. Date: Jun. 11, 2020

(54) METHOD AND DEVICE FOR CONSOLIDATING A COMPOSITE FIBER STRUCTURE

(71) Applicant: Dieffenbacher GmbH Maschinen- und Anlagenbau, Eppingen (DE)

(72) Inventors: Michael ECHLE, Eppingen (DE); Felix MANGER, Eppingen (DE)

(73) Assignee: Dieffenbacher GmbH Maschinen- und Anlagenbau, Eppingen (DE)

(21) Appl. No.: 16/707,678

(22) Filed: Dec. 9, 2019

(30) Foreign Application Priority Data
Dec. 10, 2018 (DE) 10 2018 131 574.0

(51) Int. Cl. B29C 70/44; B29C 35/08

(52) U.S. Cl. CPC B29C 70/443; B29C 70/54; B29C 35/0805

(57) ABSTRACT

A method and a device are provided for consolidating a fiber composite structure with at least one thermoplastic and/or thermoelastic polymer. The fiber composite structure is arranged between two pressing elements of a device for consolidating the fiber composite structure. The pressing elements are pushed toward one another such that the fiber composite structure is pressed therebetween. The fiber composite structure is heated at least into the range of a melting temperature of the at least one polymer. After cooling, the consolidated fiber composite structure is removed from the device. At least one separate compensating element is arranged in the region of at least one height difference of the fiber composite structure, between the structure and one of the pressing elements, such that the at least one height difference with respect to the one of the pressing elements is compensated with the at least one compensating element.

### CROSS-REFERENCE TO RELATED APPLICATIONS

This application claims the benefit of priority to German Patent Application No. 10 2018 131 574.0, filed Dec. 10, 2018, the entire contents of which are incorporated herein by reference.

### FIELD

The invention relates to a method for consolidating a fiber composite structure with at least one thermoplastic and/or thermoelastic polymer, in which method the fiber composite structure is arranged between two pressing elements of a device for consolidating the fiber composite structure, wherein the pressing elements are pushed toward one another in such a way that the fiber composite structure is pressed between the pressing elements, wherein the fiber composite structure is heated at least into the range of a melting temperature of the at least one thermoplastic and/or thermoelastic polymer, and wherein the consolidated fiber composite structure is removed from the device after cooling.

The invention further relates to a device for consolidating fiber composite structures with at least one thermoplastic and/or thermoelastic polymer, wherein the device comprises two pressing elements between which the fiber composite structure may be arranged for consolidation, at least one pressing device with which the pressing elements may be pushed toward one another in such a way that the fiber composite structure is pressed between the pressing elements, and at least one heating device with which the fiber composite structure may be heated.

### BACKGROUND

From DE 10 2017 105 450 A1, a method for consolidating a fiber composite structure with at least one thermoplastic and/or thermoelastic polymer is specified, comprising arranging the fiber composite structure between a plate-shaped base and a plate-shaped cover in a loading/unloading station of a conveying device, wherein the cover is sealed with respect to the base by a sealing element so as to be displaceable in relation to the base; generating a negative pressure in the intermediate space between the base and the cover so that the ambient pressure pushes the cover against the base and the fiber composite structure is pressed between the cover and the base; heating the fiber composite structure by means of electromagnetic radiation, preferably at least into the range of the melting temperature of the at least one thermoplastic and/or thermoelastic polymer, in a heating station of the conveying device; cooling the fiber composite structure in a cooling station of the conveying device; and removing the consolidated fiber composite structure from the base, or removing the base occupied by the consolidated fiber composite structure, from the conveying device. A cover provided with a cavity may be suitably used as a covering for consolidation in order to reinforce fiber composite structures having at least one height difference with the aforementioned method.

### SUMMARY

The invention is based on the object of designing a method and a device of the aforementioned type which may be adapted more flexibly and quickly to height differences of fiber composite structures to be consolidated.

This object is achieved according to the invention in the method in that at least one separate compensating element is arranged in the region of at least one height difference of the fiber composite structure, between the fiber composite structure and one of the pressing elements, in such a way that the at least one height difference with respect to said one of the pressing elements is compensated with the at least one compensating element.

According to the invention, at least one compensating element is used as a spacer with which the at least one height difference of the fiber composite structure is compensated in such a way that a uniform height is realized overall. A step-free, in particular flat surface may thus be realized on the side of the fiber composite structure with the at least one compensating element, which side faces toward said pressing element. In this way, the pressing elements may likewise be equipped with step-free, in particular flat surfaces on their sides facing toward the fiber composite structure. The pressing elements may thus be produced more easily and used more flexibly. The same pressing elements may thus also be used for fiber composite structures which have different height differences. In order to compensate for the different height differences, compensating elements matching the height differences are individually inserted. The same consolidation device may thus be used more flexibly for fiber composite structures with different height differences.

The at least one compensating element passes through the consolidation process with the fiber composite structure. The at least one compensating element prevents displacements and evening out of the surface of the fiber composite structure from occurring when the pressing elements are pressed together. Without the at least one compensating element, flat surfaces of the pressing elements would level out the at least one height difference so that it disappears. The fiber composite structure would lose the desired shape.

Height differences are required in order to adapt the fiber composite structure to its intended purpose and to the necessary conditions. Component geometries, load introductions, reinforcing ribs, or the like may be realized in fiber composite structures with the aid of height differences. Height differences have the effect that the fiber composite structure has a height which varies across its extent in width and length. The height of the fiber composite structures may also be referred to as a “thickness.” Accordingly, a height difference may also be referred to as a “difference in thickness.”

By using correspondingly adapted compensating elements, it is not necessary to adapt the pressing elements themselves to the corresponding height differences of the fiber composite structure, as is required given the covering known from the prior art. In this way, the pressing elements may be used more flexibly for differently shaped fiber composite structures. An expenditure, in particular with respect to tools and/or assembly costs, for example for a tool change, may thus be reduced.

Advantageously, at least one inner side of at least one of the pressing elements which faces toward the fiber composite structure may be flat. In this way, a uniform pressing pressure may be exerted on the fiber composite structure. Furthermore, flat sides may be realized more easily.

At least one of the pressing elements may advantageously be plate-shaped. Plate-shaped pressing elements may be produced more easily than in particular curved and/or structured pressing elements. Furthermore, at least one surface may be flat in plate-shaped pressing elements.

Advantageously, at least one of the pressing elements can be flexurally stable. In this way, a uniform pressure may be exerted on the fiber composite structure.

Alternatively or additionally, at least one of the pressing elements may be flexible. In this way, said pressing element may be flexibly pressed against the fiber composite structure, particularly by means of a negative pressure.

At least one of the pressing elements may advantageously be designed as a film. A flexible pressing element may thus be realized easily.

One of the pressing elements, in particular a base, may advantageously be a mechanically stable, less deformable plate. The other pressing element, in particular a cover, may be a film or a metal sheet. In this way, the pressing elements may be designed to be more flexible overall.

The pressing elements may advantageously be moved toward one another and pushed by means of a negative pressure and/or at least one mechanical, electromechanical, hydraulic drive or similar, even a combined drive. In this way, the corresponding compressive force between the pressing elements can be preset in a controlled manner.

At least one of the pressing elements for electromagnetic radiation, in particular infrared radiation, may advantageously be at least partially transparent. In this way, the fiber composite structure may be heated by means of corresponding radiation sources which may be arranged on an outside of the pressing elements or may irradiate at least said pressing elements.

At least one of the pressing elements may advantageously be made of a material that is at least partially transparent to electromagnetic radiation, in particular infrared radiation.

Alternatively or additionally, at least one of the pressing elements may be partially transmissive or impermeable to electromagnetic radiation, in particular infrared radiation. This may prevent the fiber composite structure from being heated by means of the electromagnetic radiation from the side with the at least one partially transmissive or impermeable pressing element. This may be advantageous in particular if excessive heating from one side is undesirable based on the design of the fiber composite structure, in particular because this could lead to overheating of the fiber composite structures and to damage. Alternatively or additionally, one of the pressing elements may also be covered at least partially with radiation-reflecting means so that absorption, and thus direct heating of the underlying fiber composite structure, also does not take place at the covered locations. Further alternatively or additionally, the electromagnetic radiation may also be controlled in such a way that radiation is applied to only the regions covered by the fiber composite structure.

The fiber composite structures may preferably be carbon fiber-reinforced plastic or the like. The fiber composite structures may be realized as continuous fiber-reinforced components. Especially textile fiber semi-finished products, such as fiber yarns and/or textile fabrics wetted with a binder and/or partially or completely impregnated with a matrix, what are known as prepregs, such as fiber woven fabrics, fiber knitted fabrics, fiber non-crimp fabrics, or fiber mats, may be used for continuous fiber-reinforced components. In particular, materials from the groups of thermoplastics, and possibly additional plasticizing components, such as elastomers, which differ in terms of strength, maximum elongation, operating temperature, processing speed, and chemical resistance may be used as binder and/or matrix materials.

The fiber composite structures may be realized as what are known as tapes. In this context, a tape preferably means any type of web-like material, in particular a prepreg material. Such tapes may in particular have a width between 30 mm and 200 mm. Tapes are suitable for placement by means of what is known as a tape laying device.

The fiber composite structures may advantageously be used for realizing automobile components. Corresponding shapes and contours of the components made of the fiber composite structure may thus be designed more flexibly with the aid of the invention.

In an advantageous embodiment of the method, at least one compensating element may be fixed to one of the pressing elements, and the fiber composite structure may be arranged with respect to the pressing element such that the at least one compensating element is brought together with the corresponding at least one height difference, and/or at least one compensating element may be brought together with the corresponding at least one height difference of the fiber composite structure independently of the pressing elements.

The at least one compensating element may advantageously be fixed to one of the pressing elements. The at least one compensating element may thus be prepared with the pressing element. The at least one compensating element may remain on the pressing element when the fiber composite structure is removed. The fiber composite structure may be positioned such that the at least one compensating element fixed to the pressing element is brought together with the corresponding at least one height difference.

The at least one compensating element may advantageously be fixed to the at least one pressing element so as to be detachable. In this way, the at least one compensating element may be replaced easily. The device for consolidation may thus be more easily adapted to fiber composite structures having differently arranged and/or differently designed height differences.

Alternatively or additionally, at least one compensating element may be brought together with the corresponding at least one height difference of the fiber composite structure independently of the pressing elements. The at least one compensating element may in this case first be brought together with the at least one height difference. The fiber composite structure with the at least one compensating element may subsequently be arranged between the pressing elements. In this way, the fiber composite structure with the at least one compensating element may also be prepared outside of the device for consolidation and subsequently be arranged between the pressing elements.

Alternatively or additionally, at least one compensating element may be brought together with the corresponding at least one height difference after the fiber composite structure has been placed on a pressing element, especially a spatially lower pressing element. A spatially upper pressing element may subsequently be placed in such a way that the fiber composite structure with the at least one compensating element is arranged between the pressing elements. In this way, the fiber composite structure may be stably placed on the lower pressing element while the at least one compensating element is brought together with the at least one height difference.

In a further advantageous embodiment of the method, the consolidated fiber composite structure may be removed after cooling, wherein at least one compensating element remains on at least one pressing element; and/or after cooling, the consolidated fiber composite structure may be removed together with the at least one compensating element, and after the removal, the at least one compensating element may be removed from the consolidated fiber composite structure; and/or the at least one compensating element may be separated from the consolidated fiber composite structure, and the consolidated fiber composite structure may subsequently be removed.

The consolidated fiber composite structure may advantageously be removed, wherein at least one compensating element remains on at least one pressing element, in particular is held there. In this way, the fiber composite structure may be separated from the at least one compensating element without an additional tool. The at least one compensating element may continue to be used without redesign for further use, in particular for consolidating a further fiber composite structure with the same at least one height difference.

Alternatively or additionally, at least one compensating element may remain in the region of the at least one height difference upon removal of the consolidated fiber composite structure and be separated from the fiber composite structure after removal of the consolidated fiber composite structure. In this way, the at least one compensating element does not need to be fixed to the at least one pressing element. After removal, the fiber composite structure may be bent somewhat, whereby separation of the at least one compensating element is facilitated. The at least one compensating element may thus also be separated from the fiber composite structure if the at least one compensating element is connected, in particular glued or cemented, to the fiber composite structure during consolidation of said fiber composite structure.

Alternatively or additionally, at least one compensating element may be separated from the consolidated fiber composite structure before the fiber composite structure is removed. In this way, the consolidated fiber composite structure may remain more stably placed on the pressing element, especially on the lower pressing element. In this way, deformations of the consolidated fiber composite structure upon separation of the at least one compensating element may be avoided.

Alternatively or additionally, the compensating element may be placed with a gap relative to the surrounding fiber composite structure, in a plane perpendicular to the height of the fiber composite structure, wherein the gap is preferably less than 3 mm, particularly preferably less than 2 mm, most preferably less than 1 mm. Even given small inaccuracies in the blank of fiber composite structure and/or compensating element, these may thus be used. In particular, different thermal expansions of fiber composite structure and compensating element may also be taken into account by the gap.

The object of the device is furthermore achieved according to the invention in that the device has at least one separate compensating element which is shaped on the corresponding side to be complementary to at least one height difference of the fiber composite structure, and which is or can be arranged between the pressing elements.

According to the invention, at least one separate compensating element is provided which is shaped to be complementary to the at least one height difference of the fiber composite structure. In this way, the at least one height difference on the side facing toward the respective pressing element may be compensated. The at least one compensating element thus serves, in a manner of speaking, as a spacer which fills the at least one height difference.

The at least one compensating element may advantageously be flat on its side opposite the complementary side. In this way, the contour of this side may transition steplessly into the contour of the adjacent surface of the fiber composite structures.

The at least one compensating element is separate. This means that it is not fastened to one of the pressing elements or is fastened only so that it can be detached non-destructively. The at least one compensating element may thus be arranged more flexibly.

From a selection of differently shaped compensating elements, that compensating element may advantageously be used which matches the at least one height difference of the fiber structure that is currently to be consolidated. Overall, the device may thus be operated more flexibly.

The device for consolidating fiber composite structures may be part of a loading and/or unloading station of a conveying device. In this way, the fiber composite structures can be conveyed toward the consolidation device and/or the consolidated fiber composite structures can be conveyed away from the consolidation device.

In an advantageous embodiment, at least one compensating element may be permeable or partially permeable to electromagnetic radiation, or at least one compensating element may be reflective to electromagnetic radiation. In this way, the heating of at least one compensating element by electromagnetic radiation can be avoided or at least reduced.

Advantageously, the electromagnetic radiation can be infrared radiation. Infrared radiation can be used to heat the fiber composite structures for consolidation.

Advantageously, the electromagnetic radiation can be generated by means of the heating device.

Advantageously, at least one compensating element can be non-absorbent or slightly absorbent to electromagnetic radiation.

Transparent compensating elements have the advantage that the electromagnetic radiation can radiate through them and thus reach and heat the corresponding region of the fiber composite structure covered by the at least one compensating element.

Alternatively or additionally, at least one compensating element can be reflective to electromagnetic radiation. In this way, less or no electromagnetic radiation can reach the surface of the fiber structure in the region of the fiber composite structure covered by the at least one compensating element. This is particularly advantageous if the region of the fiber composite structure in which the at least one compensating element is located has a relatively low height. This can prevent this region from becoming too hot, which can lead to damage.

In an additional advantageous embodiment, at least one compensating element may have a mechanical compressibility that, at least in the direction of the force with which the pressing elements press the fiber composite structure, is equal to or less than the corresponding compressibility of the fiber composite structure. In this way, the at least one compensating element causing a greater compression of the fiber composite structure in the region of the at least one compensating element, and thus of the at least one height difference, during the pressing together of the fiber composite structure than outside the region of the height difference can be avoided. In this way, the at least one compensating element causing a change to the at least one height difference when pressing the fiber composite structure can be avoided.

In an additional advantageous embodiment, at least one compensating element can be at least partially flexible. In this way, the at least one compensating element can be demolded from the fiber composite structure more easily. This means that any bending forces during demolding and removal of the compensating element can be better compensated. Such bending forces can arise in particular if the at least one compensating element forms a connection, in particular cementing or adhesion or the like, with the fiber composite structure in the consolidation process. Such connections must be separated upon demolding.

Advantageously, at least one compensating element can be at least partially elastic. In this way, it can regain its original shape after deformation.

In an additional advantageous embodiment, at least one compensating element may exhibit the same thermal behavior or at least a similar thermal behavior as the fiber composite structure. In this way, the at least one compensating element being deformed in relation to the fiber composite structure during heating, whereby the at least one height difference would be deformed, can be avoided. The same or similar thermal behavior can avoid or reduce corresponding mechanical stresses between the at least one compensating element and the fiber composite structure, which would change the surface structure of the fiber composite structure.

Preferably, the compensating element has properties congruent to the fiber composite structure. The compensating element thus has thermal, mechanical and/or electrical properties that are at least almost identical to those of the fiber composite structure.

Advantageously, the melting temperature of the at least one compensating element can be at least as high as the melting temperature of the fiber composite structure and/or the polymers. In this way, the at least one compensating element being deformed more than the fiber composite structure when the pressing elements are pressed together, which would reduce the compensating function of the at least one compensating element, can be avoided.

Advantageously, the thermal expansion of the at least one compensating element can be lower than the thermal expansion of the fiber composite structure. In this way, the at least one compensating element extending beyond the region of the at least one height difference can be avoided.

In an additional advantageous embodiment, at least one compensating element may comprise or consist of glass, quartz glass, composite material, metal or a combination of different materials. In this way, the required mechanical and/or thermal properties can be achieved with the corresponding material or a combination of materials.

Advantageously, at least one compensating element may comprise or consist of chrome-plated, polished or similarly machined metal. Thus, mirrored surfaces reflecting electromagnetic radiation can be realized.

Advantageously, the at least one compensating element can be made of stainless steel, non-heat-expanding steel, aluminum or the like. In this way, the required mechanical and thermal stability can be achieved.

Advantageously, at least one compensating element can be made of the same material as the fiber composite structure.

Alternatively or additionally, the at least one compensating element can be a disposable product that must be disposed of after a single use. This is the case in particular if the compensating material does not have reversible properties and has undergone a physical and/or chemical change from its original form after consolidation.

Alternatively or additionally, at least one compensating element can comprise or consist of the same material as at least one of the pressing elements. In this way, the at least one compensating element can better withstand the thermal and mechanical forces occurring during consolidation.

In an additional advantageous embodiment, at least one compensating element can have, at least on its side facing toward the fiber composite structure, a surface that does not adhere to the fiber composite structure, and/or at least one compensating element can be non-adhesively coated for the fiber composite structure, at least on the side facing toward the fiber composite structure, and/or at least one separating layer can be arranged between at least one compensating element and the fiber composite structure, which separating layer can prevent or minimize adhesion of the fiber composite structure to the surface of the at least one compensating element.

In this way, a connection, in particular cementing or adhesion or the like, between the at least one compensating element and the fiber composite structure can be prevented or at least reduced.

Advantageously, at least one separating film can be arranged between the at least one compensating element and the fiber composite structure. The at least one separating film can prevent the at least one compensating element from adhering to the fiber composite structure.

Advantageously, at least one separating film can be firmly attached to the at least one compensating element. In this way, the at least one separating film can be easily arranged together with the at least one compensating element prior to the consolidation process at the height difference of the fiber composite structure and separated from the fiber composite structure after the consolidation process.

Advantageously, the device for consolidation may have a double chamber arrangement. The pressing elements and, between them, the fiber composite structure with the at least one compensating element can be arranged in the double chamber arrangement. The double chamber can have an outer chamber and an inner chamber. The outer chamber surrounds the inner chamber. The pressing elements with the fiber composite structure are arranged in the inner chamber. By means of corresponding negative pressures, the pressing elements can be pressed together and the fiber composite structure can thus be pressed in. With the aid of the double chamber arrangement, air pockets between the at least one compensating element and the fiber composite structure can be avoided.

Alternatively or additionally, the separating layer is achieved by a separating film or by spraying a release agent onto the fiber composite structure and/or the compensating element.

In all other respects, the features and advantages shown in connection with the method according to the invention and the device according to the invention and their respective advantageous embodiments apply mutatis mutandis to each other and vice versa. Naturally, the individual features and advantages can be combined with each other, wherein further beneficial effects, which go beyond the sum of the individual effects, can be achieved.

Further advantages, features and details of the invention arise from the following description, in which exemplary embodiments of the invention are explained in more detail on the basis of the drawings. It is expedient for the person skilled in the art to individually consider the features disclosed in the drawings, the description and the claims in combination, and to combine them into sensible further combinations.

### BRIEF DESCRIPTION OF THE DRAWINGS

The following is schematically shown

FIG. 1 a device for consolidating a fiber composite structure with a thermoplastic and/or thermoelastic polymer according to a first exemplary embodiment, in a method step of placing the fiber composite structure on a lower pressing element;

FIG. 2 the device from FIG. 1 in a method step of arranging a compensating element in a recess of the fiber composite structure;

FIG. 3 the device from FIGS. 1 and 2 in a method step in which the fiber composite structure with the inserted compensating element is pressed between the lower pressing element and an upper pressing element and heated with infrared heating;

FIG. 4 the device from FIGS. 1 to 3 in a method step in which the compensating element is separated from the consolidated fiber composite structure;

FIG. 5 the device from FIGS. 1 and 2 in a method step according to an alternative method for consolidating the fiber composite structure, in which the fiber composite structure with the inserted compensating element is placed on the lower pressing element;

FIG. 6 the device from FIG. 5 in a method step in which the fiber composite structure with the inserted compensating element is pressed between the lower pressing element and the upper pressing element and heated with the infrared heating;

FIG. 7 the device from FIGS. 5 and 6 in a method step in which the consolidated fiber composite structure is removed, and the compensating element is removed from the removed consolidated fiber composite structure;

FIG. 8 a device for consolidating a fiber composite structure according to a second exemplary embodiment, in which the compensating element is attached to the lower pressing element, in a method step according to an additional alternative method, in which the fiber composite structure is placed on the lower pressing element;

FIG. 9 the device from FIG. 8 in a method step in which the fiber composite structure with the inserted compensating element is pressed between the lower pressing element and the upper pressing element and heated with infrared heating;

FIG. 10 the device of FIGS. 8 and 9 in a method step in which the consolidated fiber composite structure is removed from the lower pressing element, wherein the compensating element remains on the lower pressing element.

In the figures, the same components are provided with the same reference signs.

### DETAILED DESCRIPTION

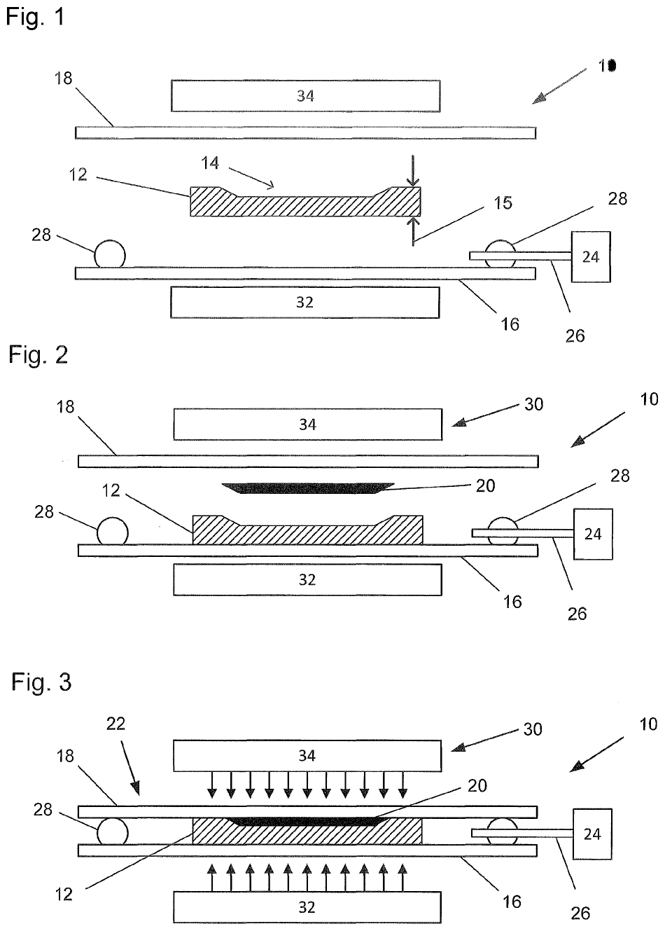

FIGS. 1 to 4 show a device 10 for consolidating a fiber composite structure 12 in different method steps.

The fiber composite structure 12 is, for example, a so-called tape scrim, which is made up of individual tapes consisting of fibers connected to thermoplastic and/or thermoelastic polymer. With the device 10 for consolidation, the fiber composite structure 12 is pressed and heated.

Components manufactured from the fiber composite structure 12 can be used, for example, in the automotive industry.

The fiber composite structure 12 has a recess 14 on one side, on top in FIG. 1. The fiber composite structure 12 with the recess 14 is, for example, prefabricated from a continuous web.

The recess 14 forms a height difference in the fiber composite structure 12. A height difference means that the height 15 of the fiber composite structure 12 changes in this region. The height 15 is the extent of the fiber composite structure 12 perpendicular to its length and width. In this exemplary embodiment, the height 15 is perpendicular to an upper surface in FIG. 1 and a lower surface of the fiber composite structure 12. In the case of the recess 14, the height 15 of the fiber composite structure 12 is reduced in comparison to the adjacent regions.

The device 10 has a lower pressing element 16 and an upper pressing element 18. The pressing elements 16, 18 are permeable to infrared radiation. The pressing elements 16 and 18 are realized, for example, as flat plates made of quartz glass. The lower pressing element 16 is mounted, for example, on a support device not shown, such as a table.

The device 10 also has a compensating element 20. On one side, at the bottom of FIG. 1, the compensating element 20 is complementary to the recess 14 in the fiber composite structure 12. On the opposite side, at the top of FIG. 1, the compensating element 20 is flat. The compensating element 20 consists of a material that, by way of example, has the same mechanical properties and the same thermal behavior as the fiber composite structure 12. The melting temperature of the compensating element 20 is above the melting temperature of the polymers of the fiber composite structure 12. The compensating element 20 is also, by way of example, permeable to infrared radiation. For example, the compensating element 20 can consist of the same quartz glass as the pressing elements 16, 18.

In addition, the compensating element 20 has a non-adhesive surface on the side facing toward the recess 14, at the bottom of FIG. 1. The surface is coated, for example, with polytetrafluoroethylene (PTFE).

Furthermore, the device 10 comprises a pressing device 22. With the pressing device 22, the pressing elements 16 and 18 can be moved toward each other and pushed. The pressing device 22 is equipped, for example, with a vacuum pump 24, which is connected to an intermediate space between the pressing elements 16, 18 by means of a vacuum connection 26. The vacuum connection 26 passes through a sealing element 28. The sealing element 28 is arranged between the pressing elements 16, 18 and surrounds the fiber composite structure 12 in a circumferentially contiguous manner.

Apart from that, the device 10 has a heating device 30. The heating device 30 comprises a lower infrared radiator 32 and an upper infrared radiator 34. The lower infrared radiator 32 is arranged under the lower pressing element 16 and is pointed toward the lower pressing element 16. The upper infrared radiator 34 is arranged above the upper pressing element 18 and is pointed toward the upper pressing element 18.

The method for consolidating the fiber composite structure 12 according to a first exemplary embodiment is explained below with reference to FIGS. 1 to 4.

In a method step shown in FIG. 1, the fiber composite structure 12 is placed on the lower pressing element 16 with the recess 14 pointing upward toward the upper pressing element 18.

Subsequently, in a method step shown in FIG. 2, the compensating element 20 is arranged with the complementary, coated side first in the recess 14.

The upper pressing element 18 is then placed on the fiber composite structure 12. The vacuum pump 24 is activated. Negative pressure is applied to the intermediate space between the pressing elements 16, 18, which is sealed off from the environment by the sealing element 28. By means of the negative pressure, the pressing elements 16, 18 are moved toward each other and pushed. In the process, the fiber composite structure 12 is pressed between the pressing elements 16, 18.

The heating device 30 heats the fiber composite structure 12 by passing infrared radiation through the pressing elements 16, 18 to the fiber composite structure 12. Since the compensating element 20 is permeable to infrared radiation, the infrared radiation from the upper infrared radiator 34 passes through the upper pressing element 16 and the compensating element 20 to the upper side of the fiber composite structure 12 in the region of the recess 14.

By means of the infrared radiation, the polymer of the fiber composite structure 12 is heated to above its melting temperature and melted. Thus, in conjunction with the mechanical pressure exerted by the pressing elements 16, 18, the fiber composite structure 12 is consolidated.

After completion of the heating process, the fiber composite structure 12 is cooled. A cooling device not shown can be used for this purpose, for example.

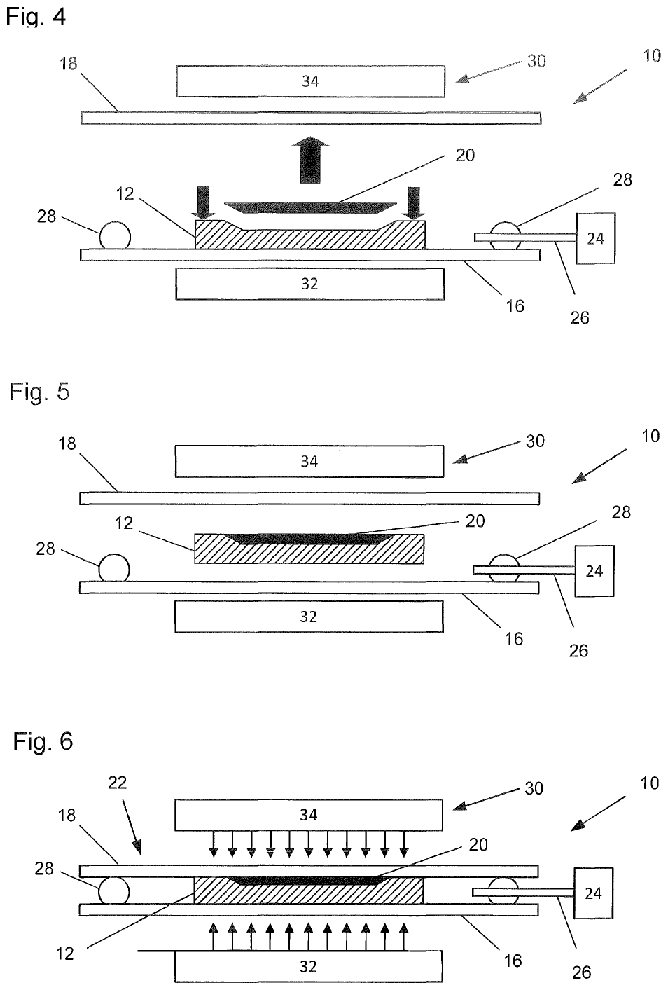

After cooling, the upper pressing element 18 is removed. As shown in FIG. 4, the compensating element 20 is removed from the recess 14. The consolidated fiber composite structure 12 is then removed from the device 10.

FIGS. 5 to 7 show the method steps for consolidating the fiber composite structure 12 with the device 10 from FIGS. 1 to 4 according to an alternative exemplary embodiment of the method. The elements that are similar to those of the first exemplary embodiment of the method from FIGS. 1 to 4 are provided with the same reference signs. The alternative exemplary embodiment of the method differs from the first exemplary embodiment of the method in that, with the alternative exemplary embodiment of the method, the compensating element 20 is initially arranged in the recess 14. The fiber composite structure 12 with the inserted compensating element 20 is then placed on the lower pressing element 16. This is shown in FIG. 5. Thereafter, the fiber composite structure 12, as shown in FIG. 6, is heated and pressed, analogously to the first embodiment of the method according to FIG. 3 there. The consolidated fiber composite structure 12 is then cooled.

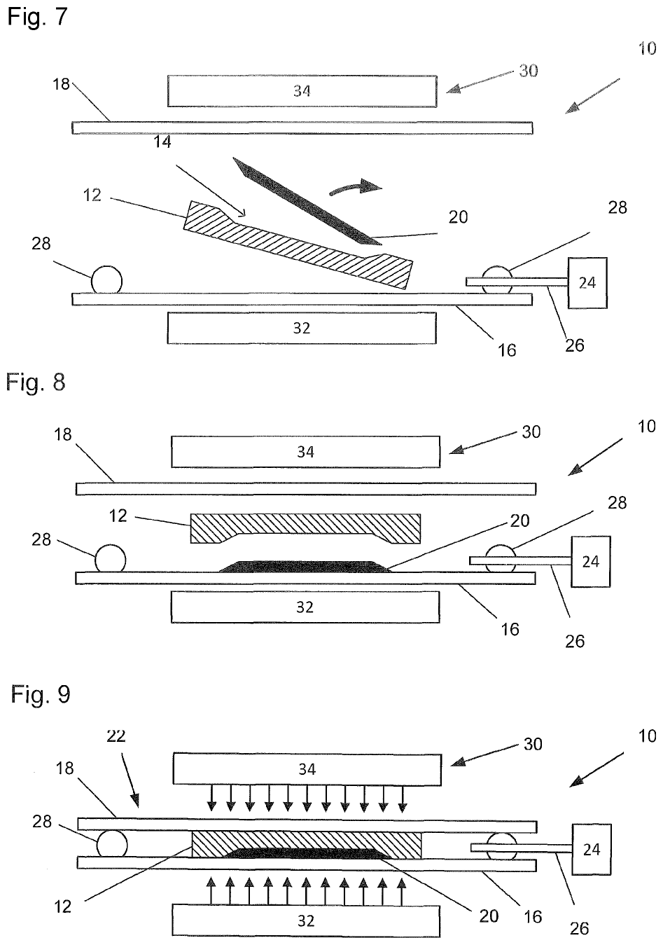

After the consolidated fiber composite structure 12 has cooled, the consolidated fiber composite structure 12 together with the compensating element 20 is first removed from the device 10 in a method step shown in FIG. 7. The compensating element 20 is then removed from the recess 14 of the consolidated fiber composite structure 12.

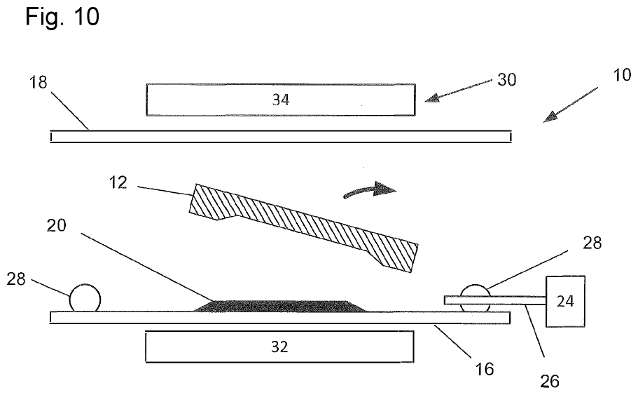

FIGS. 8 to 10 show the method steps for consolidating the fiber composite structure 12 according to an additional alternative exemplary embodiment of the method with a device 10 according to a second exemplary embodiment. The elements that are similar to those of the first exemplary embodiment of the method with the first exemplary embodiment of the device 10 from FIGS. 1 to 4 are provided with the same reference signs. The device 10 according to the second exemplary embodiment according to FIGS. 8 to 10 differs from the device 10 according to the first exemplary embodiment from FIGS. 1 to 4 in that, in the second exemplary embodiment, the compensating element 20 is detachably fastened to the surface of the lower pressing element 16 facing toward the upper pressing element 18. In the method for consolidating the fiber composite structure 12 according to the additional alternative exemplary embodiment of the method, the fiber composite structure 12, as shown in FIG. 8, is placed with the recess 14 pointed toward the lower pressing element 16 on the lower pressing element 16 in such a way that the recess 16 is placed on the compensating element 20.

Subsequently, as shown in FIG. 9, the fiber composite structure 12 is consolidated analogously to the method step according to the first exemplary embodiment of the method from FIG. 3, and subsequently cooled.

After cooling, the consolidated fiber composite structure 12 is removed from the device 10. In doing so, the compensating element 20 remains on the lower pressing element 16.

### LIST OF REFERENCE SIGNS

10 Device

12 Fiber composite structure

14 Recess

15 Height of the fiber composite structure

16 Pressing element

18 Pressing element

20 Compensating element

22 Pressing device

24 Vacuum pump

26 Vacuum connection

28 Sealing element

30 Heating device

32 Infrared emitter

34 Infrared emitter

1. A method for consolidating a fiber composite structure with at least one thermoplastic and/or thermoelastic polymer, wherein
the fiber composite structure is arranged between two pressing elements of a device for consolidating the fiber composite structure,
the pressing elements are moved toward one another and pushed in such a way that the fiber composite structure is pressed between the pressing elements,
the fiber composite structure is heated at least into the range of a melting temperature of the at least one thermoplastic and/or thermoelastic polymer,
after cooling, the consolidated fiber composite structure is removed from the device,
wherein at least one separate compensating element is arranged in the region of at least one height difference of the fiber composite structure, between the fiber composite structure and one of the pressing elements, in such a way that with the at least one compensating element, the at least one height difference with respect to said one of the pressing elements is compensated.

2. The method according to claim 1, wherein at least one compensating element is fixed to one of the pressing elements, and the fiber composite structure is arranged with respect to the pressing element in such a way that the at least one compensating element is brought together with the corresponding at least one height difference; and/or at least one compensating element is brought together with the corresponding at least one height difference of the fiber composite structure independently of the pressing elements.

3. The method according to claim 1, wherein the consolidated fiber composite structure is removed after cooling, wherein at least one compensating element remains on at least one pressing element; and/or after cooling, the consolidated fiber composite structure is removed together with the at least one compensating element, and after removal, the at least one compensating element is removed from the consolidated fiber composite structure; and/or the at least one compensating element is separated from the consolidated fiber composite structure and the consolidated fiber composite structure is subsequently removed.

4. The method according to claim 1, wherein the compensating element is placed with a gap relative to the surrounding fiber composite structure, in the plane perpendicular to the height of the fiber composite structure, wherein the gap is preferably less than 3 mm, particularly preferably less than 2 mm, most preferably less than 1 mm.

5. A device for consolidating fiber composite structures with at least one thermoplastic and/or thermoelastic polymer, wherein the device comprises
two pressing elements, between which the fiber composite structure may be arranged for consolidation,
at least one pressing device with which the pressing elements may be moved toward one another and be pushed in such a way that the fiber composite structure is pressed between the pressing elements,
at least one heating device with which the fiber composite structure may be heated,
wherein the device has at least one separate compensating element which, on the corresponding side, is shaped to be complementary to at least one height difference of the fiber composite structure and which is or can be arranged between the pressing elements.

6. The device according to claim 5, wherein at least one compensating element is transmissive or partially transmissive to electromagnetic radiation, or at least one compensating element is reflective to electromagnetic radiation.

7. The device according to claim 5, wherein at least one compensating element has a mechanical compressibility which is equal to or less than the corresponding compressibility of the fiber composite structure, at least in the direction of the force with which the pressing elements press the fiber composite structure.

8. The device according to claim 5, wherein at least one compensating element is at least partially flexible.

9. The device according to claim 5, wherein at least one compensating element has the same thermal behavior or at least a similar thermal behavior as the fiber composite structure.

10. Device The device according to claim 5, wherein at least one compensating element comprises glass, quartz glass, composite material, metal, or a combination of different materials.

11. The device according to claim 5, wherein at least one compensating element has a surface that does not adhere to the fiber composite structure, at least on its side facing toward the fiber composite structure; and/or at least one compensating element is coated so as to be non-adhesive for the fiber composite structure, at least on the side facing toward the fiber composite structure; and/or at least one separating layer is arranged between at least one compensating element and the fiber composite structure, which at least one separating layer prevents or minimizes adhesion of the fiber composite structure to the surface of the at least one compensating element.

12. The device according to claim 11, wherein the separating layer is achieved by a separating film or by spraying a release agent onto the fiber composite structure and/or the compensating element.
